(19) United States
(12) Patent Application Publication
(10) Pub. No.: US 2018/0133803 A1
(43) Pub. Date: May 17, 2018

(54) MULTI-MATERIAL FUNCTIONAL PARTS USING ADDITIVE MANUFACTURING

(71) Applicant: SCHLUMBERGER TECHNOLOGY CORPORATION, Sugar Land, TX (US)

(72) Inventor: Srinand Sreedharan Karuppoor, Sugar Land, TX (US)

(21) Appl. No.: 15/815,816

(22) Filed: Nov. 17, 2017

Related U.S. Application Data
(60) Provisional application No. 62/423,611, filed on Nov. 17, 2016.

(51) Int. Cl. B22F 7/04; B22F 3/00; B28B 1/00; B33Y 10/00; B33Y 80/00; F01D 5/02

(52) U.S. Cl. CPC B22F 7/04; B22F 3/008; B28B 1/001; E21B 1/00; B33Y 80/00; F01D 5/02; B22F 2007/045; B33Y 10/00

(57) ABSTRACT

A method of forming a component includes depositing successive layers of a binder and first particles of a first material using a layering device to build a first green segment, depositing successive layers of the binder and second particles of a second material different than the first material using the layering device to build a second green segment, assembling the first green segment and the second green segment together to form a green component, and infiltrating the green component with a metallic infiltrant to form the component.

### CROSS-REFERENCE TO RELATED APPLICATIONS

This application claims the benefit of, and priority to, U.S. Patent Application No. 62/423,611, filed Nov. 17, 2016, and titled “Multi-material Functional Parts using Binder Jet Additive Manufacturing,” which application is incorporated herein by this reference in its entirely.

### BACKGROUND

A variety of components are utilized for drilling earth formations, and to improve drilling efficiency, the components are often designed and tailored for the specific type of earth formation that is to be encountered. For example, oilfield tools may experience harsh operating conditions, and tool components may therefore fulfill multiple functionalities, e.g., resistance toward corrosion, wear, heavy loads, and impacts. To fulfill multiple functionalities, a tool may have a body made of a base material for the primary load-bearing function and some supplemental coatings (claddings) for wear or corrosion resistance (e.g., wear bands on drill collars).

Some oilfield tools may be formed via infiltration processes, where a matrix or hard particle powder may be infiltrated by a metallic binder. For example, after designing a matrix body drill hit, a mold is often formed to serve as a template during the fabrication of the component. Matrix material for forming the drill bit may be placed in the mold and then infiltrated with a metallic binder.

Some components utilized for drilling earth formations, such as motor components, valve seats and sleeves, are often formed using a machining process. For example, a sleeve used in a downhole operation may be formed by machining the sleeve body from a steel material, where the machined sleeve may then have one or more outer surfaces coated or treated (e.g., carburized) to provide an outer surface with different properties than the body.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments of the present disclosure relate to methods of forming a component that include depositing successive layers of a binder and first particles of a first material using a layering device to build a first green segment, depositing successive layers of the binder and second particles of a second material different than the first material using the layering device to build a second green segment, assembling the first green segment and the second green segment together to form a green component, and infiltrating the green component with a metallic infiltrant to form a component.

In another aspect, embodiments of the present disclosure relate to methods that include designing a component using a computer aided design program, the component having at least two segments, depositing a binder and matrix material layer by layer using a layering device to build each segment separately, assembling the at least two segments together to form a green component, and infiltrating the green component with a metallic infiltrant to form the component.

In yet another aspect, embodiments of the present disclosure relate to components for downhole operation equipment that include a microstructure having a metallic infiltrant dispersed in a matrix of at least two types of matrix material particles, wherein each type of matrix material particle is in a separate region of the component, and an interlocking interface between two of the separate regions.

Other aspects and features of the present disclosure will be apparent from the following description and the appended claims.

### BRIEF DESCRIPTION OF DRAWINGS

FIG. 1 shows a method according to embodiments of the present disclosure.

FIG. 2 shows a diagram of a layering device for use in methods according to embodiments of the present disclosure.

FIG. 3 shows a method according to embodiments of the present disclosure.

FIG. 4 shows a method of forming a component according to embodiments of the present disclosure.

FIG. 5 shows a method according to embodiments of the present disclosure.

FIG. 6 shows a cross sectional view of a green component according to embodiments of the present disclosure.

FIG, 7 shows a component according to embodiments of the present disclosure.

FIG. 8 shows the microstructure of a component formed according to embodiments the present disclosure.

FIG. 9 shows a component according to embodiments of the present disclosure.

FIGS. 10 and 11 show a top and bottom view, respectively, of a component according to embodiments of the present disclosure.

FIG. 12 shows a component according to embodiments of the present disclosure.

FIG, 13 illustrates an exploded, perspective view of a turbine drive assembly having multiple rotor stages, according to some embodiments of the present disclosure.

FIG. 14 shows a cross sectional view of a blender according to embodiments of the present disclosure.

FIG. 15 shows a perspective view of a blender according to embodiments of the present disclosure.

FIG. 16 shows a cross sectional view of wear bands according to embodiments of the present disclosure disposed around a mandrel.

FIG. 17 shows a cross sectional view of a stabilizer according to embodiments of the present disclosure.

FIG. 18 shows a cross sectional view of a flow diverter according to embodiments of the present disclosure.

FIG. 19 is a cross sectional view of a pump according to embodiments of the present disclosure.

FIG. 20 shows a schematic side view of a transversal cut through of a reusable filter cartridge according to embodiments of the present disclosure.

FIG. 21 shows a nozzle according to embodiments of the present disclosure.

FIG, 22 shows a valve having a valve seat according to embodiments of the present disclosure.

FIG. 23 shows a heat exchanger according to embodiments of the present disclosure.

### DETAILED DESCRIPTION

Embodiments of the present disclosure relate generally to methods of making a component for downhole operation equipment that include 3D printing separate segments of the component and joining the segments together. Separately formed segments of a component may be joined together by positioning the segments adjacent to each other and infiltrating the segments into an integral piece.

Components formed from infiltrated together segments may have a microstructure that includes a metallic infiltrant dispersed throughout a matrix of at least two types of matrix material particles, where each type of matrix material particles may be separated in different regions. A single metallic infiltrant may be provided through the microstructure of a component having multiple regions of different matrix materials by building segments of the component in a layer-by-layer manner, alternating layers of matrix material and binder, assembling the segments, burning off the binder, and infiltrating the assembled segments,

According to embodiments of the present disclosure, segments of a component may be formed using binder jetting. Binder jetting is a type of additive manufacturing process that builds objects by layering powdered material and a binder, where the binder (e.g., an organic or polymer binding agent) joins the layers of powdered material (matrix material particles) to hold the shape of the component. Other additive manufacturing techniques using a layering device to build alternating layers of a matrix material and a binder may be used to build segments according to embodiments of the present disclosure.

Suitable matrix materials may be provided in powdered form, and may include particles of metals, ceramics and/or cermets. For example, matrix material particles may include, but are not limited to, steel, such as carbon tool steel or high speed steel, cast cobalt alloys, cemented carbides, such as tungsten carbide, tantalum carbide, titanium carbide or other transition metal carbide, carbonitrides, alumina, silicon carbide, and cubic boron nitride.

Suitable binder materials may include, for example, phenolic binders, aqueous-based binders and other organic binders known in the art. Suitable metallic infiltrant materials may include, for example, a bronze alloy, a copper alloy, a nickel-based alloy, a cobalt alloy, and combinations thereof.

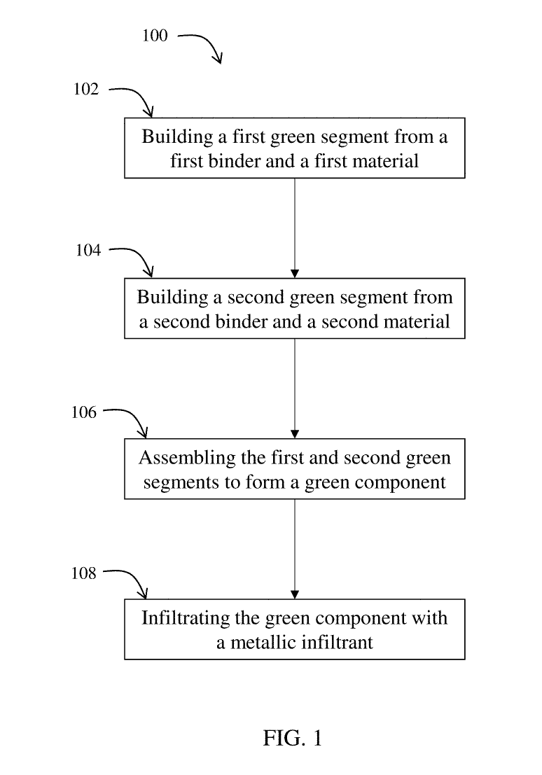

FIG. 1 shows an example of a method of making a component according to embodiments of the present disclosure. The method 100 may include building a first green segment from a binder and a first material 102 by depositing successive layers of the first binder and particles of the first material (e.g., depositing the first material in powdered form) using a layering device. The method 100 further includes building a second green segment from a second binder and a second material 104 by depositing successive layers of the binder and particles of the second material (e.g., depositing the second material in powdered form) using the layering device, the second material different from than first material. The first binder and second binder may be different or the same. The first and second green segments may be assembled together to form a green component 106.

According to embodiments of the present disclosure, binder may be removed from a green segment or green component by burning out the binder, for example, by heating the green component in a vacuum oven to a temperature that decomposes the binder. In some embodiments, binder may be removed from a green part by chemically decomposing the binder. Binder removal from a green component (or from green segments when binder is removed from the green segments prior to assembling into a green component) may leave a network of pores throughout the green component.

Referring still to FIG. 1, the green component may then be infiltrated with a metallic infiltrant 108, where the metallic infiltrant may infiltrate through the pore network created by the binder removal. Metallic infiltrants may include, for example, copper, cobalt, molybdenum, bronze, or alloys thereof, or any suitable low melting temperature alloy that may enable fusion of the matrix material particles.

Green segments of the present disclosure may be formed by depositing layers of binder and matrix material using a layering device. Layers of binder and matrix material may be deposited in an alternating pattern, such that a layer of binder may be deposited between and bind together sandwiching layers of matrix material. The layers may be deposited in a selected area and at a selected thickness to build the three dimensional shape of the final segment.

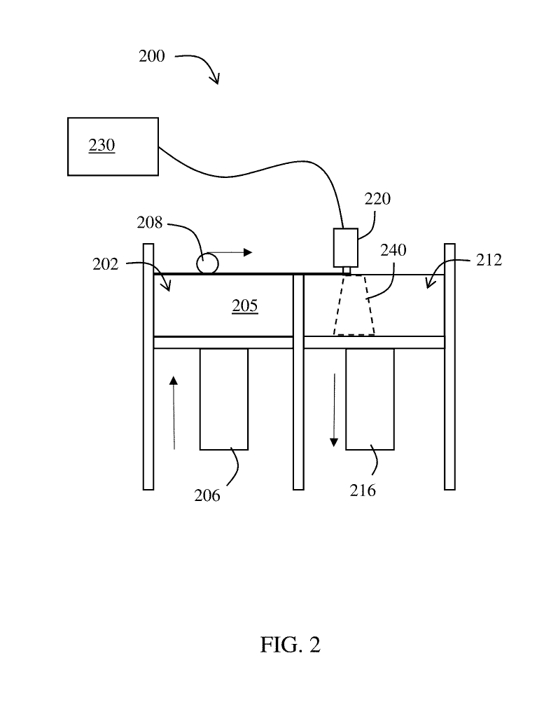

FIG. 2 shows an example of a layering device suitable for forming green segments according to embodiments of the present disclosure. The layering device shown is a binder jet 200 having a supply chamber 202 for feeding a supply of powdered matrix material 205 and a build chamber 212 for receiving powdered matrix material from the supply chamber 202. Powdered matrix material 205 may be provided in the supply chamber 202, which may be deposited from the supply chamber 202 to the build chamber 212. As shown, a feed piston 206 may be positioned below a floor of the supply chamber 202 to push the powdered matrix material 205 supply upwards. A leveling roller 208 may roll an amount of powdered matrix material 205 into a layer in the build chamber 212. As layers of powdered matrix material 205 are rolled into the build chamber 212, a powder bed of the matrix material builds in height. Accordingly, a build piston 216 positioned below the floor of the build chamber 212 may lower the powder bed as it is built up in order to keep the top of the powder bed in the build chamber level with (or at a depth substantially equal to the thickness of the matrix material layer to be deposited) the top of the powdered matrix material 205 in the supply chamber 212.

After a layer of powdered matrix material is rolled into the build chamber 212, a deposition device 220 may deposit a binder supplied from a binder supply 230 over the deposited layer of powdered matrix material in a pattern. The pattern may have the same shape/design as a cross sectional layer of a three dimensional design of a segment 240 being built. The deposited binder may thus bind the deposited layer of powdered matrix material into the cross section layer of the segment 240. Subsequent layers of powdered matrix material and binder may be deposited in similar fashion to build the three dimensional shape of the segment 240. In other words, the roller 208 may deposit a layer of matrix material in powder form in the build chamber 212, and binder may be selectively deposited over the layer of matrix material by the deposition device 220, where the matrix material layer deposition and binder deposition steps may be repeated until a three dimensional part is built.

According to embodiments of the present disclosure, a binder may be deposited in different amounts relative to a matrix material deposited when forming a green segment. In an embodiment, the different amount may be measured as a volume ratio of binder to matrix material. The volume ratio may be varied through a height and/or through a thickness (or cross sectional area perpendicular to the height) of a green segment, for example, by depositing different thicknesses of binder and/or matrix material during building the green segment.

For example, in some embodiments, a green segment may be formed by depositing two or more alternating layers of matrix material having a first thickness and binder material having a first thickness, and depositing at least one layer of matrix material and/or binder having a different thickness. In some embodiments, the amount of binder being deposited in a single layer may be varied through the single layer, for example, where relatively greater amounts of binder may be deposited in one portion of the single layer and relatively smaller amounts of binder may be deposited in another portion of the single layer.

In some embodiments, the volume ratio of binder to matrix material may vary between green segments forming a green component. For example, a first green segment may have a firs volume ratio of binder to a first matrix material, and a second green segment may have a second volume ratio of binder to a second matrix material, where the first volume ratio is different than the second volume ratio of binder to matrix material.

By providing varying volume ratios of binder to matrix material within a green segment and/or within a green component, varying porosity may be formed through the matrix material after the binder is removed (e.g., burned off). A metallic infiltrant may then be infiltrated into the segment and/or component, where the metallic infiltrant may at least partially fill the pores remaining from the removed binder (e.g., up to about 90% of the porosity, or up to 99% of the porosity).

According to embodiments of the present disclosure, the microstructure of a component (or a region of the component) may be designed to have varying volume ratios of metallic infiltrant to matrix material by designing the green component of the component to have varying amounts of binder relative to matrix material corresponding to the designed volume ratios of metallic infiltrant to matrix material in the component. For example, a region of a component may have a varying volume ratio of metallic infiltrant to matrix material through the region by providing a green segment that forms the region of the component with varying amounts of binder relative to the matrix material. In some embodiments, the microstructure of a component may be designed to have a relatively high volume ratio of metallic infiltrant to matrix material in a first region of the component and a relatively low volume ratio of metallic infiltrant to matrix material in a second region of the component. To build the component having the designed microstructure, segments of the component may be built by layering amounts of binder relative to layered amounts of matrix material that correspond to the amounts of metallic infiltrant to be infiltrated into the component, such that the amounts of infiltrated metallic infiltrant achieve the relatively high and relatively low volume ratios of metallic infiltrant to matrix material in the first and second regions, respectively, of the component.

Components of the present disclosure may be designed, for example, using a computer aided design (“CAD”) program. A component may then be built based on a component design from the CAD program. For example, methods of the present disclosure may include designing a component formed of at least two segments using a CAD program, depositing a binder and matrix material layer by layer using a layering device to build each segment separately, assembling the at least two segments together to form a green component, and infiltrating the green component with a metallic infiltrant to form the component.

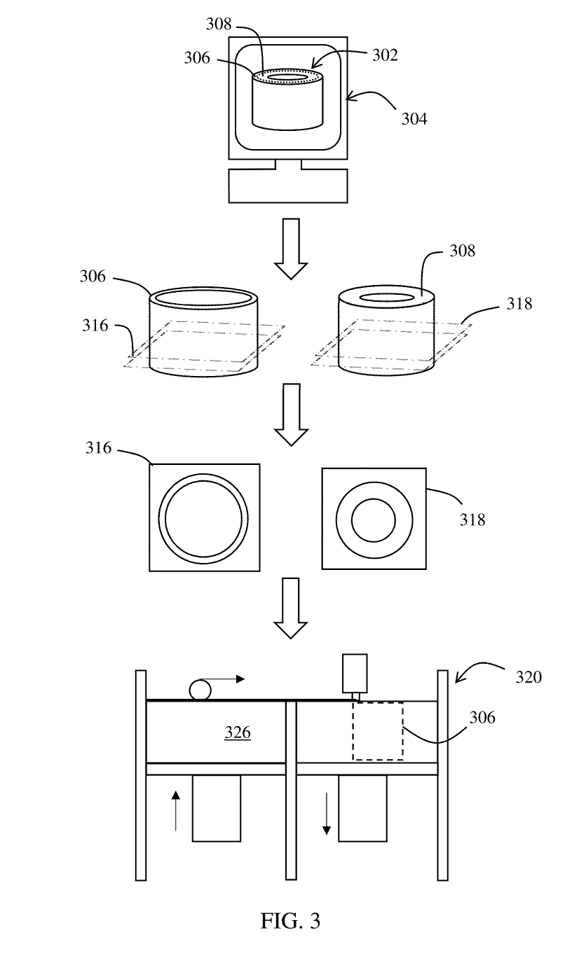

FIG. 3 shows an example of a method according to embodiments of the present disclosure. As shown in FIG. 3, an additive manufacturing process for making a component 300 may begin by providing a CAD model 302 of the component 300 and determining its placement within a build chamber, or build box, of a layering device using a computer aided interface 304. In some embodiments, multiple CAD models of components (or multiple models of segments) may be arrayed within the build chamber to maximize the efficiency of the additive manufacturing process by completing multiple component or multiple segments during the same deposition session. In the embodiment shown, the component 300 is formed of a first segment 306 (forming an outer region of the component) and a second segment 308 (forming an inner region of the component).

The multiple segments 306, 308 of the CAD model 302 may each be divided into multiple layers 316, 318 to draw detailed information for each layer that will be deposited, thereby allowing the layering device 320 to be programmed to form each layer.

The additive manufacturing process may then proceed with building the first and second segments 306, 308 from the CAD model 302. The deposition process for building the first segment 306 is shown in FIG. 3; however, a layering device may build the second segment 308 in the same manner. As shown, a layer of the material composition 326 to form the first segment 306 may be deposited throughout the build chamber of a layering device 320. A binder or adhesive may then be applied to the specific areas of the build chamber where the segment 306 will be according to the placement of the CAD model in the build chamber. For example, the computer aided pattern based on the placement of the model in the build chamber dictates where the binder or adhesive is applied. In some embodiments, the application of the binder or adhesive to the specific areas of the build chamber may be achieved by spraying the binder or adhesive. For example, using a technology similar to ink-jet printing, a binder material is sprayed on and joins particles in the locations of the build chamber where the object is to be formed.

After the application of the adhesive or binder to a layer of particles, another layer of material composition 326 may be spread across the build chamber of the layering device 320 and then another pass of a binder or adhesive may be applied on the designated areas of the new material composition layer to form a second layer of the first segment 306. The layer of particles may be spread across the build chamber using known methods, e.g., a hopper may feed the powder to an arm which may spread the powder as it travels across the box. The process of layering the material composition throughout the build chamber followed by applying a binder or adhesive to the designated areas may be repeated until each layer forming the first segment 306 is deposited. The first segment 306 may then be harvested or removed from the build chamber for further processing. The support gained from the powder bed (i.e., the regions of powder that do not include the adhesive or binder) allows overhangs, undercuts, and internal volumes to be created as long as there is a hole or pathway for the loose powder to escape.

Second segment 308 may be built from the CAD model 302 using the same layering device 320 (after or bethre building the first segment 306) or using a different layering device. In embodiments having two or more different segments sequentially built with the same layering device, one or both of the feed matrix material and the binder forming each green segment may be changed between each segment being built. In some embodiments, first segment 306 and second segment 308 may be made simultaneously using a different layer devices.

The component shown in FIG. 3 is a sleeve, where the first segment 306 may form an outer region of the sleeve, and the second segment 308 may form an inner region of the sleeve. The first segment 306 may be formed of a first binder and a first matrix material 326, and the second segment 308 may be formed of a second binder and a second matrix material, where the first matrix material may be more erosion resistant than the second matrix material to provide the outer region of the finished component 300 with a greater erosion resistance than the inner region of the finished component 300. In an embodiment, the first binder and second binder are the same.

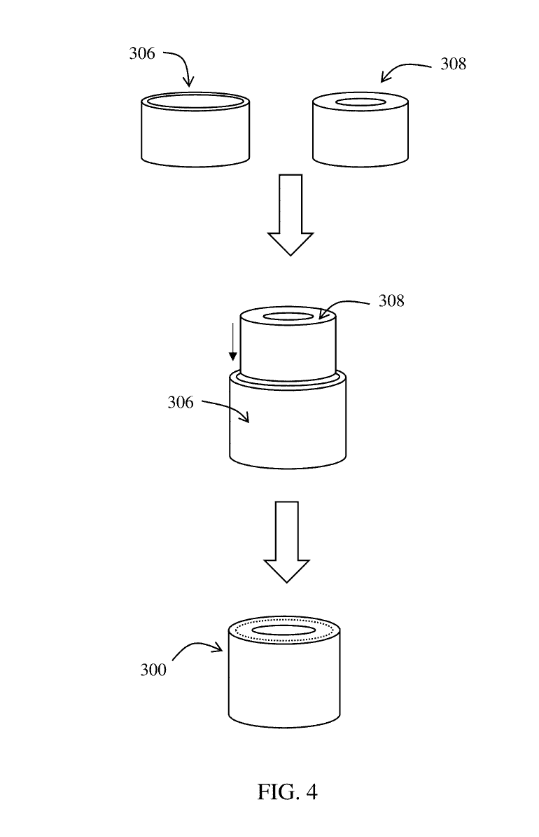

Referring now to FIG. 4, once the first and second segments 306, 308 are built, they may be assembled together to form a green component. The green component may then be infiltrated with a metallic infiltrant to form the component 300.

In some embodiments, a method of forming a component may further include hot isostatic pressing the component, i.e., subjecting the component to both elevated temperature and isostatic pressure. A component may be subjected to hot isostatic pressing after infiltration of the green component in order to reduce internal voids or micro-porosity. Hot isostatic pressing may include placing a component into a high pressure vessel or chamber, and heating and pressurizing (e.g., with an inert gas) the high pressure vessel to subject the component to high temperatures and isostatic pressure.

The multiple segments of a component may each be designed to perform a different functionality of the component. For example, referring still to FIGS. 3 and 4, the first segment 306 may be designed to have a relatively higher erosion resistance compared to the second segment 308 in order to protect the component from erosion during use of the component (where the first segment is positioned to form an outer surface of the component), and the second segment 308 may be designed to have relatively higher toughness compared to the first segment in order to provide impact resistance to the component during use. The first segment 306 may be designed to have a relatively higher erosion resistance by using a matrix material to form the first segment 306 that has higher erosion resistance than the matrix material to form the second segment 308.

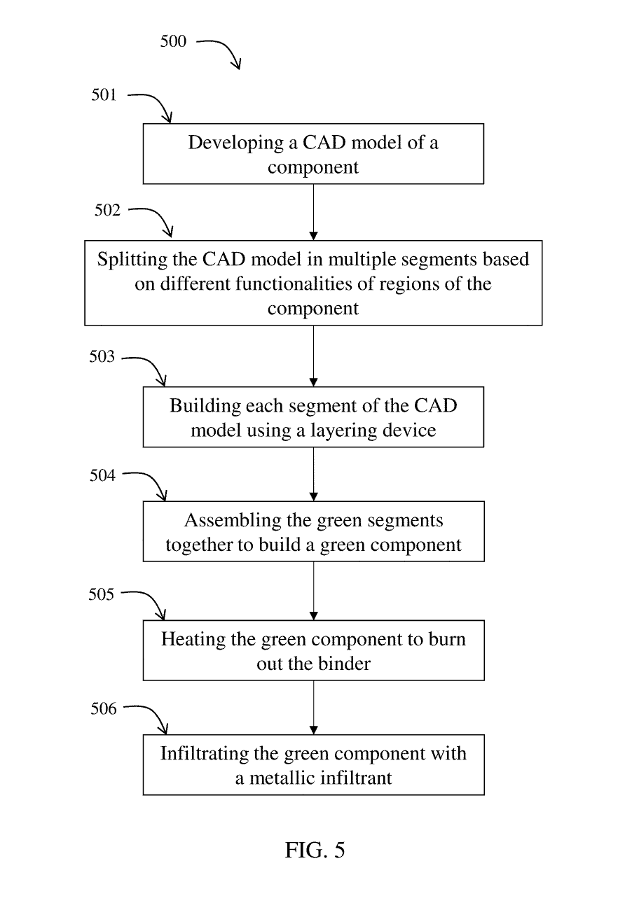

According to embodiments of the present disclosure, a method of forming a component may include designing a CAD model of the component having at least two segments using a CAD program, depositing a binder and matrix material layer by layer using a layering device to build each segment separately, assembling the at least two segments together to form a green component, and infiltrating the green component with a metallic infiltrant to form the component. FIG. 5 shows an example of a method 500 for forming a component according to embodiments of the present disclosure. The method 500 includes developing a CAD model of the component 501. The CAD model may be split into multiple segments based on regions of functionality in the component 502 (e.g., regions of a component exposed to high erosion during use may be divided into a segment having high erosion resistance; and/or regions of a component exposed to high impact may be divided into one or more segments having high toughness).

The segments from the CAD model may then be built using an additive manufacturing process 503. For example, an interface between a CAD program running on a computing system and a layering device may include a processor for receiving instructions from the CAD program and for sending signals to a motor system of the layering device to move deposition components (e.g., a leveling roller or dispensing arm for depositing a matrix material, or a print head for depositing binder) of the layering device, to pistons for raising and lowering supply and/or build chambers of the layering device, and/or to a pumping system or a gate to dispense a certain amount of binder according to the instructions received from the CAD program. Alternating layers of matrix material and binder may be deposited in the build chamber of a layering device, such as a binder jet, to build the three dimensional geometry of the segments from the CAD model.

Green segments built through binder jetting or other additive manufacturing process based on a CAD model of a component split into the segments may then be assembled together to form a green component 504. The green component may be placed in a furnace and heated to burn off the binder used in forming the green component 505 and to infiltrate the green component with a metallic infiltrant 506. The infiltrating temperature may be a temperature high enough for the matrix material and/or metallic infiltrate to fuse together. Further, in some embodiments, pressure may also be applied during heating to enable fusion of the matrix material and to reduce or remove porosities in the component.

For example, a green component may be a green drill bit having multiple green segments assembled together to form the green drill bit. First green segments of the green drill bit may include the blades of the drill bit, which may be formed by binder jetting a first tungsten carbide matrix material with a binder. A second green segment of the green drill bit may include at least a portion of the body of the drill bit, formed by binder jetting a second tungsten carbide matrix material with a binder. The bladed first green segments may be connected to the body second green segment (e.g., through tongue and groove connection, through an interlocking connection, or through another shaped interface) to form the green drill bit. In some embodiments, a third green segment may form an interior portion of the green drill bit body, where the interior green body segment may be assembled within the body second green segment to form the green drill bit. A third green segment forming an interior portion of the green drill bit body may be formed by binder jetting a steel matrix material with a binder.

The green drill bit may be placed in a vacuum furnace with metallic infiltrant disposed at the bottom of the vacuum furnace. One or more stilts may extend from the green component to the metallic infiltrant. When the temperature in the furnace reaches infiltration temperature, the stilt may wick the metallic infiltrant through the stilt and into the green component, thereby infiltrating the green component with the metallic infiltrant. The binder amount used to form the green component determines the voids remaining in the green component (once the binder has been burned out of the green component), which may be at least partially filled with the metallic infiltrant during infiltration. For example, the binder content through a green component may be varied within the green component selectively to tailor the infiltrant to matrix material volume ratio. Further, the amount of infiltrant provided during infiltration determines how much of the voids remaining in the green component are filled with metallic infiltrant.

The binders in the green drill bit may be at least partially removed and a copper based infiltrant may be infiltrated through the remaining matrix material, which may include tungsten carbide or other carbide material, to form a tungsten carbide and copper based drill bit. Other drill bits may be formed using other matrix material (e.g., other transition metal carbide, boron nitrides and/or steel) and/or a different metallic infiltrant.

According to embodiments of the present disclosure, green segments may be assembled together to form a green component by aligning mating non-planar outer surfaces of the green segments and interfacing the non-planar surfaces together. In such embodiments, green segments may be formed by additive manufacturing processes according to embodiments of the present disclosure to include non-planar interfacing surfaces, where the non-planar geometry may have at least one interlocking feature. A segment having interlocking feature(s) formed along an outer surface may be designed to interface with and interlock with a non-planar outer surface of an adjacent segment. Interlocking features formed between interfacing surfaces of adjacent segments may allow for the adjacent segments to remain in a fixed position relative to one another as the assembled segments are infiltrated.

interlocking features formed at interfaces surfaces of green segments may have various interlocking geometries, including but not limited to, threaded interlocking geometries, alternating grooves, castellations, puzzle shapes, and other non-planar shapes.

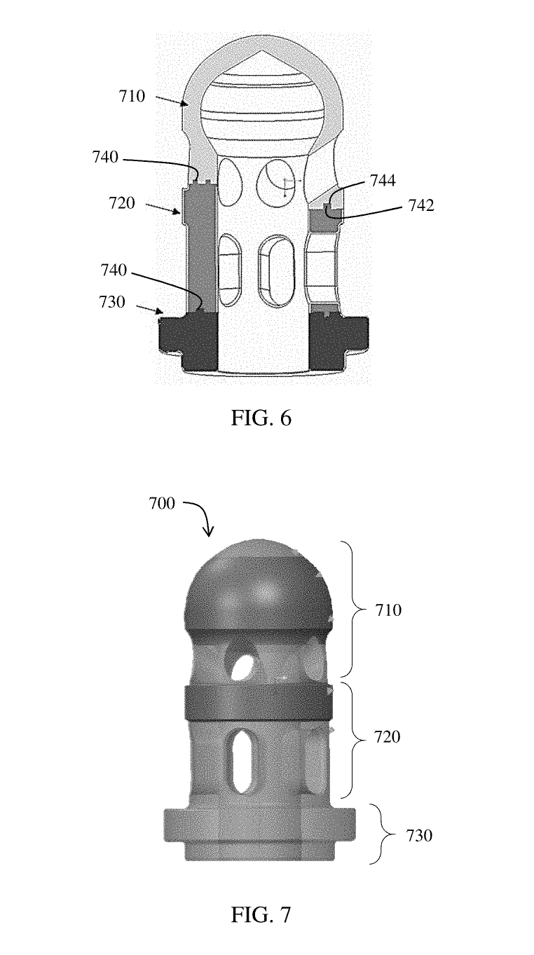

For example, FIG. 6 shows a green component 700 according to embodiments of the present disclosure having three segments 710, 720, 730 assembled together, where interfacing surfaces 740 are between adjacent segments. The interfacing surfaces 740 have interlocking features 742, 744, which may have mating geometries. For example, in the embodiment shown, the interlocking features include protrusions 742 and sockets 744, where protrusions 742 may be inserted into and fit within corresponding sockets 744. The interlocking features 742, 744 may prevent movement between adjacent segments once assembled together.

Once the segments 710, 720, 730 are assembled into a green component, the green component may be heated to burn out the binder and to infiltrate the green component with a metallic infiltrant. FIG. 7 shows the component formed from infiltrating assembled segments 710, 720, 730, which is an axial pulse generator 700 for use in downhole drilling tools.

Each segment 710, 720, 730 may be formed with a different matrix material type to provide different material properties for different functionalities of the component. For example, first segment 710 may be formed using a wear resistant or hard material as the matrix material (to provide wear resistance on the fluid flow side of the axial pulse generator), second segment 720 may be formed using a metallic material as the matrix material (to provide strength to the axial pulse generator), and third segment 730 may be formed using a tough material, which can be a matrix or non-matrix wrought or cast based material (to provide impact resistance from impacts due to the flow pulsations). The entire component 800 may have a single metallic infiltrant material disposed through different matrix materials of each segment 710, 720, 730.

According to embodiments of the present disclosure, an axial pulse generator may include a first region having a metallic infiltrant and a first type of matrix material particles, a second region positioned adjacent to the first region, the second region having the metallic infiltrant and a second type of matrix material particles, and a third region positioned adjacent to the second region, the third region having the metallic infiltrant and a third type of matrix material particles. The third type of matrix material particles may have a greater toughness than the first and second types of matrix material particles, and wherein the first type of matrix material particles may have a greater erosion resistance than the second and third types of matrix material particles.

Other components useful in downhole operations may be formed by binder jetting different segments of a component with different matrix materials and infiltrating the segments after they are assembled together into a green component. Components formed by infiltrating assembled together green segments that were formed by additive manufacturing processes using different matrix materials may have regions with different properties provided by the different matrix materials.

According to embodiments of the present disclosure, a component for downhole operation equipment may include a microstructure having a metallic infiltrant dispersed in a matrix of at least two types of matrix material particles, wherein each type of matrix material particle is in a separate region of the component. A region of a component having different matrix material particles from remaining regions of the component may form, for example, at least 5 percent by volume of the component, at least 15 percent by volume of the component, or at least 50 percent by volume of the component, and up to about 95 percent by volume of the component. In some embodiments, at least one interlocking interface may be between two of the separate regions.

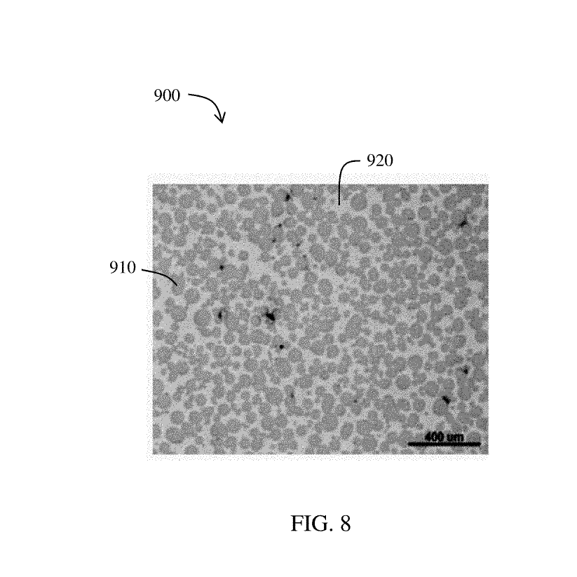

FIG. 8 shows an example of a microstructure of a component according to embodiments of the present disclosure. The component was formed by binder jetting at least two green segments using a matrix material and binder (where different matrix materials are used to form at least two different segments), assembling the green segments, burning out the binder, and infiltrating the green component with a metallic infiltrant. The resulting microstructure 900 includes a plurality of matrix material particles 910 and a metallic infiltrant 920 disposed throughout the plurality of matrix material particles 910. In the portion of the component microstructure shown, the matrix material particles 910 are steel particles and the metallic infiltrant 920 is bronze. Other portions of the component (or other embodiments) may include other types of matrix material particles and/or other types of metallic infiltrant.

The matrix material particles 910 are spherical particles. Spherical matrix material particles may be more easily deposited into layers of a controlled thickness by a binder jetting process. Further, while some of the spherical matrix material particles 910 may fuse or join together during infiltration, the particles 910 may substantially maintain their spherical shape around the joints between adjacent particles. In other embodiments, rounded matrix material particles may be used in an additive manufacturing process to form one or more segments of a component. In some embodiments, irregular, angular or other non-spherical particles may be used in an additive manufacturing process to form one or more segments of a component.

Further, the microstructure 900 shown has a mean free path between the matrix material particles 910. The mean free path between matrix material particles may be based on the amount of binder used during the additive manufacturing process used to form a segment. In some embodiments, the amount of binder deposited during an additive manufacturing process to form one or more segments of a component may be varied in order to vary the mean free path between matrix material particles in the resulting infiltrated microstructure. For example, in some embodiments, the amount of binder used to form a segment may be varied through at least a portion of the segment, such that the mean free path between matrix material particles in the resulting infiltrated segment may vary through the segment. In some embodiments, the mean free path between matrix material particles may be different in two separate regions of a component. For example, a relatively higher mean free path between matrix material particles may be provided in a first region of a component (e.g., to provide increased toughness to the first region of the component) and a relatively lower mean free path between matrix material particles may be provided in a second region (e.g., to provide increased hardness to the second region of the component).

Matrix material particles used in additive manufacturing processes of the present disclosure (e.g., binder jetting) may have uniform particle size (e.g., the matrix material particles have a particle size within about ±2% of the median particle size), which may allow for more controlled layer thickness during the layering steps in the additive manufacturing process. In some embodiments, matrix material particles may have a particle size distribution of about ±5% of the median particle size. In some embodiments, matrix material particles may have a particle size distribution of about ±15% of the median particle size. In some embodiments, matrix material particles may have a particle size distribution of about ±25% of the median particle size.

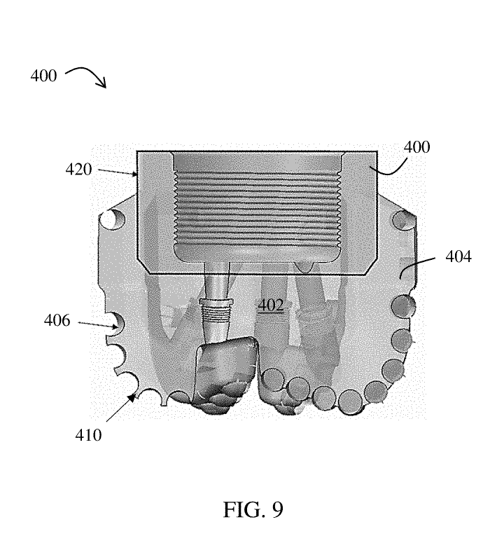

Referring now to FIG. 9, an example of a component according to embodiments of the present disclosure is shown. The component is a drill bit 400 that includes a bit body 402 and a plurality of blades 404 extending outwardly therefrom. A bit head region 410 including the blades 404 and a portion of the body 402 may be formed of a wear and erosion resistant matrix material (e.g., tungsten carbide). A threaded region 420 including the region surrounding a threaded connection portion of the bit 400 may be formed of a tough and strong matrix material (e.g., high strength steel). A single type of metallic infiltrant may be dispersed through wear and erosion resistant matrix material in the bit head region 410 and through the tough and strong matrix material in the threaded region 420.

The combination of two different types of matrix material (disposed in different regions) infiltrated with a single infiltrant type may provide the different regions of the bit with different properties, while the single infiltrant type may integrate the different regions together. For example, embodiments of the present disclosure may be used to provide a bit having a bit head region made of transition metal carbide and a copper based infiltrant and a threaded region made of high strength steel infiltrated by the same copper based infiltrant.

A plurality of cutter pockets 406 may be formed along the blades 404 of the drill bit 400 during the additive manufacturing process (as part of the three dimensional shape that was built) to form the green component of the drill bit. In some embodiments, cutter pockets may be machined into a component formed according to embodiments of the present disclosure. Cutting elements (e.g., inserts, polycrystalline diamond cutters, or other cutting element types known in the art) may be positioned within the cutter pockets 406 and brazed into place.

According to some embodiments, at least one insert or cutting element may be placed into a green component prior to infiltrating the green component. In such embodiments, a metallic infiltrant may be infiltrated through the green component and into the inserted inserts, such that the metallic infiltrant binds the inserts to the component. Inserts may be formed of a material having a melting temperature greater than the melting temperature of the metallic infiltrant, or greater than the infiltration temperature used to infiltrate the green component. For example, an insert may be formed of diamond, cubic boron nitride, other ceramic materials, and/or high melting temperature metals.

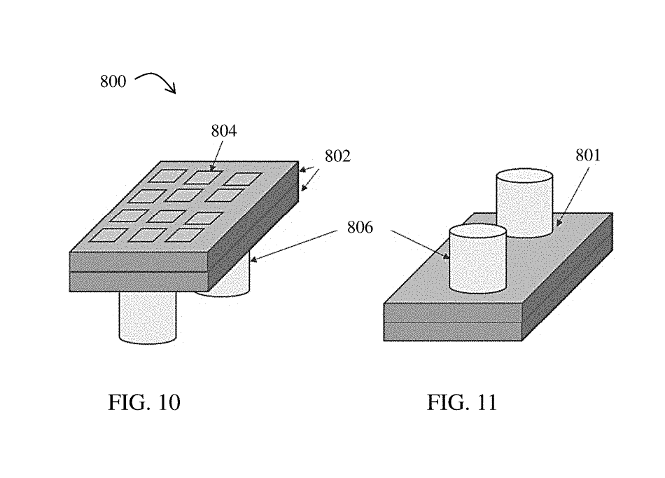

FIGS. 10 and 11 show a top view and a bottom view, respectively, of another example of a component according to embodiments of the present disclosure. The component is a wear pad 800 that includes a matrix material base 802 having a plurality of inserts 804 disposed therein. The base 802 may include two segments that sandwich around the inserts 804 to hold the inserts 804 in place. As shown, the inserts 804 are sandwiched between segments of the base 802 such that the exposed surfaces of the inserts 804 are substantially flush with a top outer surface of the base 802. In some embodiments, inserts may protrude from an outer surface of a wear pad base.

The base 802 may be made, for example, using a binder jet process (layering the matrix material with binder to form the three dimensional shape of the base). The inserts 804 may be disposed within base 802 when the base 802 is in its green state (prior to infiltration). In the embodiments shown, the base 802 segments may be formed of a tungsten carbide matrix material and the inserts 804 may be formed of diamond. Other embodiments may include wear pad bases formed of other carbide or wear resistant matrix material and/or inserts formed of other ultrahard material (e.g., cubic boron nitride).

The green component (assembled together green base segments and inserts) may then be infiltrated with a single metallic infiltrant, such as a low temperature alloy like copper or cobalt based alloys. The metallic infiltrant may infiltrate through the base 802 segments and inserts 804, thereby fusing the base segments together and holding the inserts 804 in place in the base 802.

The wear pad 800 further includes pistons 806, which are disposed at and protrude from a bottom outer surface 801 of the base 802. The pistons 806 may be used to activate or bond the wear pad 800 to another part used in a downhole drilling operation. The pistons 806 may be formed of steel, such as stainless steel. Further, the pistons 806 may be bonded to the base 802 during infiltration of the green component. In such embodiments, pistons 806 may be formed using a binder jet process, where a steel matrix material is layered with a binder to form green piston segments, and inserted into a cavity in a green base segment prior to infiltration. During infiltration, the metallic infiltrant may infiltrate through the base segments, inserts and piston segments to bond each of the segments together into an integral wear pad component 800. In some embodiments, pistons formed by machining steel bodies into the piston shape may be placed in cavities in a green base segment prior to infiltration, and during infiltration of the green base and insert assembly, the metallic infiltrant may bond/braze the machined pistons into place. In some embodiments, other additional preformed segments of a component may be brazed to the component after infiltration of the green component.

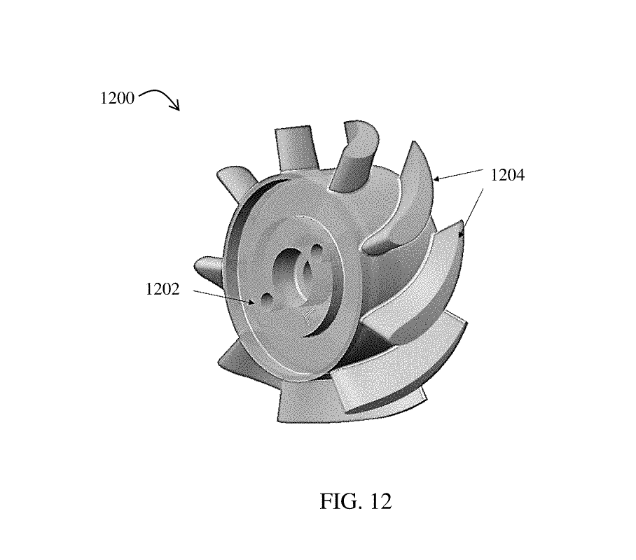

FIG. 12 shows another example of a component according to embodiments of the present disclosure. The component 1200 has a body 1202 and a plurality of blades 1204 extending outwardly from the body 1202. The component may act as a rotor when configured to be rotatable relative to a stationary housing, or may act as a stator when configured to be stationary relative to a rotatable housing. The body 1202 may be formed of a first type of matrix material and a metallic infiltrant, and the blades 1204 may be formed of a second type of matrix material and the same metallic infiltrant as the body 1202. The first type of matrix material may be a tough and strong material, such as high strength stainless steel, and the second type of matrix material may be a wear and erosion resistant material, such as tungsten carbide. The integral dispersion of the same metallic infiltrant material through the body 1202 and the blades 1204 may provide a more cohesive and integrally formed bond between the body 1202 and blades 1204.

Other components for use in downhole operation equipment may be formed according to embodiments of the present disclosure, for example, where two or more green segments of the component may be built using binder jetting, and the two or more green segments are infiltrated together with a single metallic infiltrant material. For example, components formed by binder jetting multiple green segments of a green component and infiltrating the green segments together to form the component may include but are not limited to rotating downhole operation equipment such as bits, bearings, bushings, thrust washers, turbines, cutters, coring bits, rotors, stators, blenders, mixers, gears, cams, pump stages, shafts, and sleeves, and non-rotating downhole operation equipment such as wear bands, pads, stabilizers, centralizers, collars, fasteners (e.g., nuts and bolts), threaded rings, valve seats, inserts, seals (e.g., a seal face), sucker rods, collets, anchors, mandrels, housings, tubulars, protectors, connectors, ferrules, pins, nozzles, screens and filters, and heat exchangers.

For example, FIG. 13 shows an example of a turbine drive assembly 1300 that includes a rotor 1304 having multiple stages of turbine blades 1314, and a stator 1306 for use in connection with the rotor 1304. The stator 1306 may be formed from two stator components 1308, 1310 that are positioned around the rotor 1304. The assembled rotor and stator may be placed within housing 1312, which may be configured to hold the stator 1306 stationary and/or restrict relative rotation between the housing and stator. One or more of the components forming the turbine drive assembly (e.g., the rotor, stator, and/or housing) may be formed by binder jetting multiple green segments of the component, where each green segment may be formed with a different matrix material to provide different material properties to the finished component. For example, the blades and body of the rotor may be formed from separate green segments of the blades and the body. The green segments may be infiltrated together with a metallic infiltrant to form the finished rotor component.

In some embodiments, the stator 1306 may be formed by infiltrating together multiple green segments of the stator that were binder jetted from different matrix materials. For example, stator 1306 may include an outer wall 1324 and inner rings 1320, where sets or stages of circumferentially spaced vanes 1316 may be positioned at different axial locations along the longitudinal length of the stator 1306 and extend between the inner rings 1320 and the outer wall 1324. In some embodiments, green segments of the outer wall 1324 and the spaced apart vanes 1316 may be formed by binder jetting a first matrix material and a binder, and separate green segments of the inner rings 1320 may be formed by binder jetting a second matrix material and the binder, where the second matrix material is different than the first matrix material. For example, the second matrix material may have a greater coefficient of friction than the first matrix material, and/or the first matrix material may have greater wear resistance than the second matrix material. Other combinations of green segment portions formed by binder jetting different matrix materials may be used to form a stator according to embodiments of the present disclosure.

Each set or stage, or some of the sets or stages, of the vanes 1316 are optionally configured to redirect flow of a fluid, such as drilling fluid, for use with the turbine blades 1314 of the rotor 604. For instance, in the embodiment shown, an upper stage of vanes 1316 may redirect a fluid from an axial flow to a transverse flow that strikes against an uppermost stage of turbine blades 1314. After contacting the turbine blades 1314 of the uppermost stage, the fluid may flow into a second stage of vanes 1316 within the stator 1306, which redirect the flow to transversely contact the second stage of turbine blades 1314. This process may be repeated with each successive stage of vanes 1316 of the stator 1306 and with each successive stage of turbine blades 1314 of the rotor 1304. A final, lowermost stage of vanes 1316 following the final stage of turbine blades 1314 may be omitted, or may be provided to redirect the fluid flow. For example, the final stage of vanes 1316 may redirect the fluid to flow longitudinally and about parallel to the longitudinal axis of the turbine drive 1300.

When the fluid flows against the turbine blades 1314, the fluid may cause the rotor 1304 to rotate. Each successive stage of turbine blades 1314 may provide additional power or torque when rotating the rotor 1304. In embodiments in which the rotor 1304 is integral with, permanently coupled to, or compressed against, the shaft 1302, the shaft 1302 may also rotate. As discussed herein, the shaft 1302 may rotate along with successive shafts of other turbine drives 1300 and/or be coupled to a drive shaft of a BHA. When coupled to a drive shaft of a BHA, the rotating shaft 1302 may supply power to rotate a bit, reamer, or other rotary tool of the BHA. In some embodiments, a rotating shaft and a body of a rotor may be formed from separate green segments of the shaft and the body (binder jetted using different matrix materials to form each of the green segments), where the green shaft segment and the green body segment may be assembled together and infiltrated together with a single metallic infiltrant to form an integral shaft and rotor component.

While the rotor 1304 and shaft 1302 may each rotate together, the stator 1306 may be held relatively stationary (e.g., relatively stationary relative to a housing, body, or other component of the BHA). In one embodiment, the stator 1306 may be held stationary using, at least in part, a housing 1312. In the embodiment shown, the hosing 1312 is illustrated as a sleeve that may extend around the outer wall 1324 of the stator 1306. In some embodiments, mechanical fasteners such as the tabs 1326 on the interior surface of the housing 1312 and the slots 1322 on the exterior surface of the stator 1306, or the corresponding tabs 1324 on the interior surface of the housing 1312 may be used to couple the stator 1306 to the housing 1312 and restrict, if not prevent, relative rotation there between. Other types of connectors, fasteners, or the like may be used.

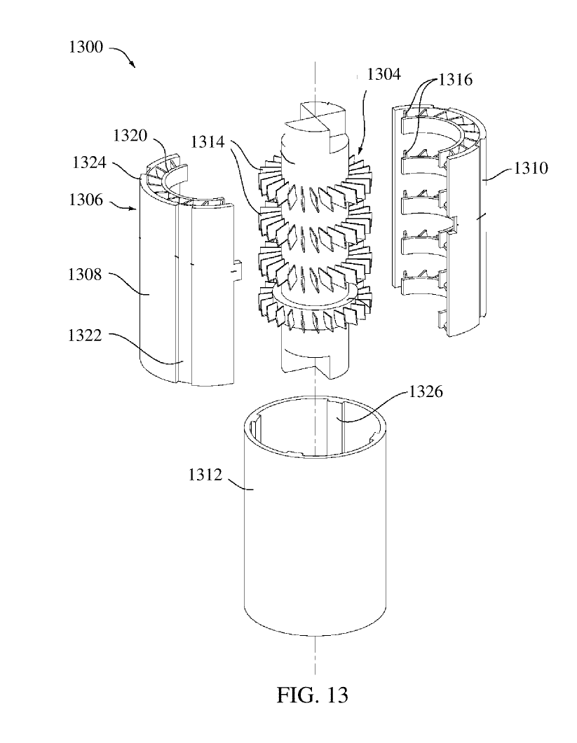

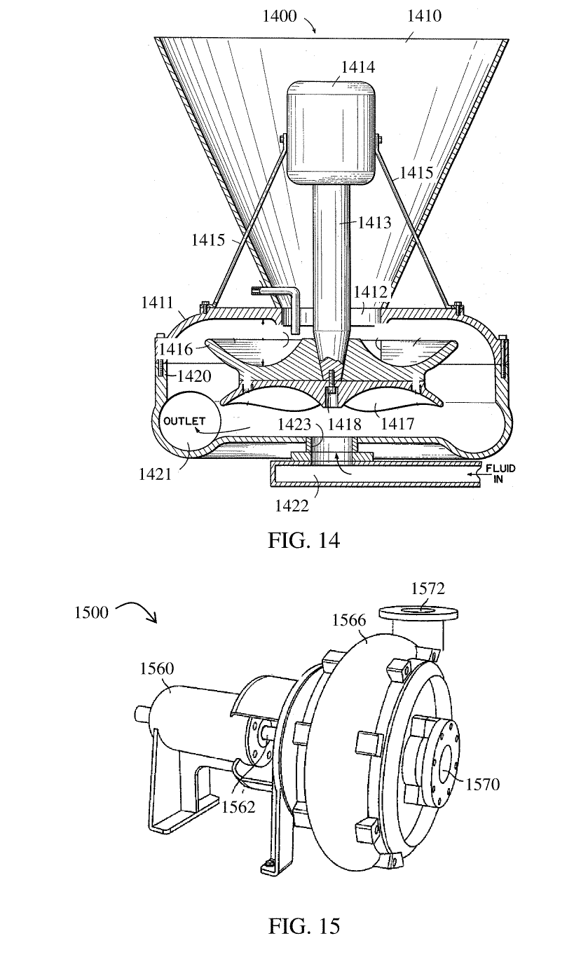

FIGS. 14 and 15 show examples of blender components that may be formed according to methods of the present disclosure. FIG. 14 is a sectional view of a blender 1400 component according to embodiments of the present disclosure, which may include a hopper 1410 for receiving and containing solid particles (e.g., sand) and a mixing chamber for mixing the solid particles with a fluid. In the embodiment shown, the hopper 1410 is mounted on the top side of a blender casing 1411 surrounding the mixing chamber. The hopper fits over an opening 1412, which provides an inlet “eye” for dropping the sand or other solid particles into the mixing chamber of the blender.

A drive shaft 1413 is positioned inside the hopper 1410, such that the bottom of the shaft extends through the inlet eye 1412 and into the casing 1411. A motor 1414 for driving the shaft is mounted at the top end of the shaft. The motor may be connected to the top cover of the casing 1411 by support rods 1415, to provide a hanger means for the motor and the drive shaft. The mixer elements of the blender apparatus may include a slinger member 1416 and an impeller member 1417. The impeller member 1417 is secured to the bottom end of the drive shaft 1413 by a bolt fastener 1418.

In addition, the slinger member may have a central opening therein (not shown) which allows it to fit over the tapered end of the drive shaft above the bolt fastener 1418. The slinger 1416 may have a toroidal configuration, including a concave surface which faces toward the top of the casing 1411. The impeller 1417 may have a vortex configuration, with a concave surface which faces toward the bottom of the casing. These design features may enhance thorough mixing of the solids with the fluid composition. The surface of slinger 1416 may be interrupted by several upstanding blade members, where the inside edge of each blade may have a vertical edge aligned approximately with the periphery of the inlet eye 1412.

The bottom part of the blender apparatus is defined by a casing 1420, which encloses the slinger 1416 and impeller 1417. Casing 1420 includes an outlet port 1421, for the discharge of material from the casing. One end of an inlet conduit 1422 is connected into the casing 1420 and the opposite end of the conduit is connected into a source for a fluid composition, such as a gel composition. During the mixing operation the fluid composition is drawn into the casing 1420 through the inlet conduit 1422 and a suction-eye inlet 1423 at the bottom of the casing.

In some embodiments, rather than attaching the impeller member to the drive shaft with a bolt fastener, the impeller member and the drive shaft may be formed of at least two separate green segments (by binder jetting different matrix materials with a binder to form each segment) that are assembled together with the binder removed, and then infiltrated with a metallic infiltrant to form an integral impeller and drive shaft component. In some embodiments, the slinger member 1416 and the impeller member 1417 may be formed of separate green segments, each green segment formed by binder jetting different matrix materials with a binder, where the separate green members are assembled together with the binder removed and then infiltrated together with a single metallic infiltrant according to embodiments of the present disclosure to form an integral slinger member and impeller member component.

Other combinations of different regions of the blender may be formed according to embodiments of the present disclosure. Combinations of different regions may be selected between regions that may otherwise be attached together with a fastener, where integrally infiltrating the regions together may provide a stronger multi-purpose component than using a fastener attachment. For example, the impeller member and the slinger member may be integrally infiltrated together, as described above using a binder jetting and infiltrating method according to embodiments of the present disclosure, to provide a stronger slinger and impeller component compared to separate slinger and impeller components attached together with a bolt or other fastener.

In some embodiments, combinations of different regions that are binder jetted and infiltrated together according to the present disclosure may be selected between regions of a single component subjected to different operating environments. For example, the drive shaft 1413 may have a first region subjected to erosion in the hopper 1410 and a second region subjected to torque at the connection between the drive shaft and the slinger member 1416. The first and second regions of the drive shaft 1413 may be formed by binder jetting different matrix material green segments, assembling the different green segments together, removing the binder, and infiltrating the green segments together to form an integral drive shaft component having different material properties in the different regions to better handle the different operating conditions.

FIG. 15 is a perspective view of another type of blender 1500 component according to embodiments of the present disclosure, where the blender 1500 may include a feed inlet 1572, a fluid inlet 1570, a mixing chamber 1566, and a motor 1560 for rotating a drive shaft 1562 to mix the feed and fluid mixture in the mixing chamber. At least two different regions may be formed by binder jetting at least two different green segments, each segment formed with a different matrix material, and infiltrating the green segments together with a single metallic infiltrant.

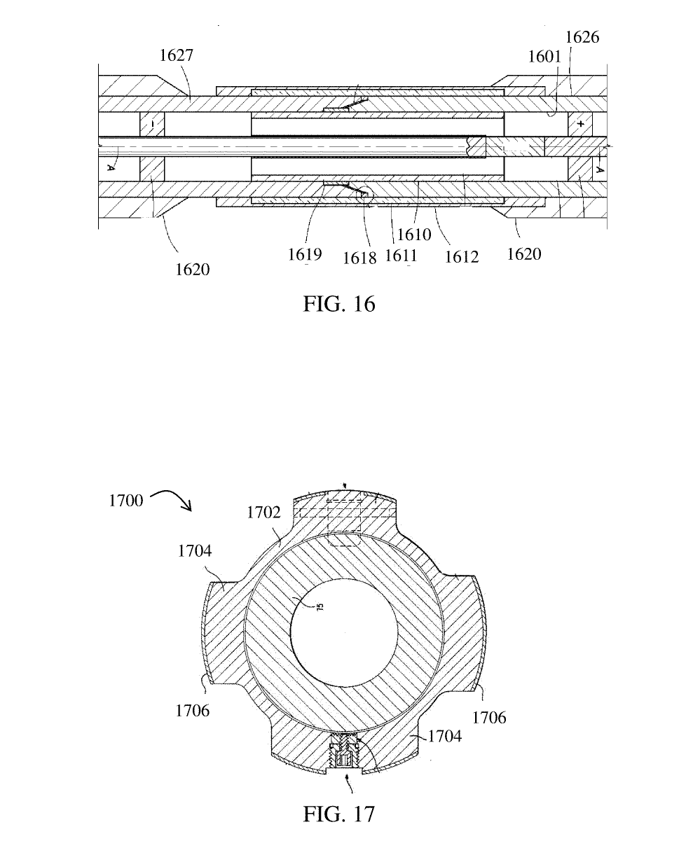

FIG. 16 shows an example of another component according to embodiments of the present disclosure, where the component is a wear band 1620. As shown, wear bands 1620 made according to methods disclosed herein may be positioned around drill collars. A metal ring or bearing 1618 may be disposed between an upper drill collar 1626 and a lower drill collar 1627 to facilitate contact there between. An inner sleeve 1619 may also be provided along the inner surface of the mated drill collars, which may provide an additional layer of protection. An inner molded insulation layer 1610 may be disposed inside passage 1601 along the inner surface of the drill collars. An outer molded insulation layer 1611 may be disposed about the outer surface of the drill collars. In some embodiments, the inner and outer molded insulation layers are molded to the surface of the drill collars to provide a hydraulic seal. Because drill collars 1626 and 1627 are between insulation layers 1610 and 1611, a seal is created about the drill collars. The insulation layers 1610 and 1611 may be made of an elastomeric, or rubber, and non-conductive material adapted to provide a hydraulic seal. The material may be moldable so that it may conform to the shape of the adjacent component (e.g., the mandrel or the drill collars). An example of a rubber that may be used is a nitril rubber.

A protective layer 1612 may be disposed about the outer insulation layer 1611. In some embodiments, the protective layer and/or outer insulation layer may extend across drill collars 1626 and 1627 to provide a protective seal about the joint there between. The protective layer 1612 may be a sleeve extending along upper drill collar 1626 and lower drill collar 1627, and surrounding insulation layer 1611. The protective layer may be a non-conductive material that provides a hardened surface to protect the underlying insulation layer.

Wear bands 1620 are positioned about the drill collars 1626 and 1627 and may or may not overlap layer 1612. The wear bands 1620 may include a region formed of a hardened metal segment at the wear band outer surfaces adapted to receive the major impact of forces applied downhole, and a region formed of a relatively tougher segment at the wear band interior. Wear bands 1600 provide a raised contact surface, or standoff, in some embodiments, to further protect the outer surface of the downhole unit. This may provide an initial point of contact for the drilling tool as it passes through the wellbore.

The hardened metal segment and relatively tougher segment may he formed by binder jetting methods described herein. The green segments may be assembled together and have the binder removed to form a green wear band component. The green wear band component may then be infiltrated with a metallic infiltrant to form the wear band component.

FIG. 17 shows a cross sectional view of a stabilizer 1700 component formed according to methods of the present disclosure, where at, least two green segments are binder jetted and infiltrated together to form the stabilizer 1700. The stabilizer 1700 includes an elongated sleeve body 1702 having a plurality of outwardly directed blades 1704. An outermost surface region 1706 of the blades 1704 may be formed of surface layer green segments, and the blades and body may be formed from a single green segment forming the blades and body together or may be formed from separate blade and body green segments, where separate green segments are formed of different matrix material. The separate green segments may be assembled together, have the binder removed, and infiltrated together with a single infiltrant to form the stabilizer 1700.

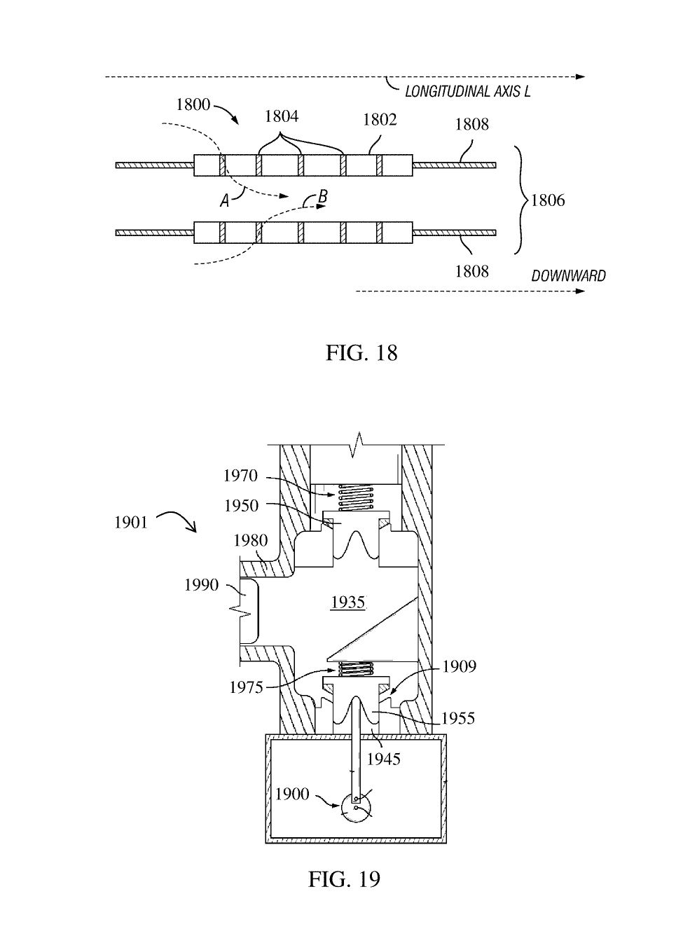

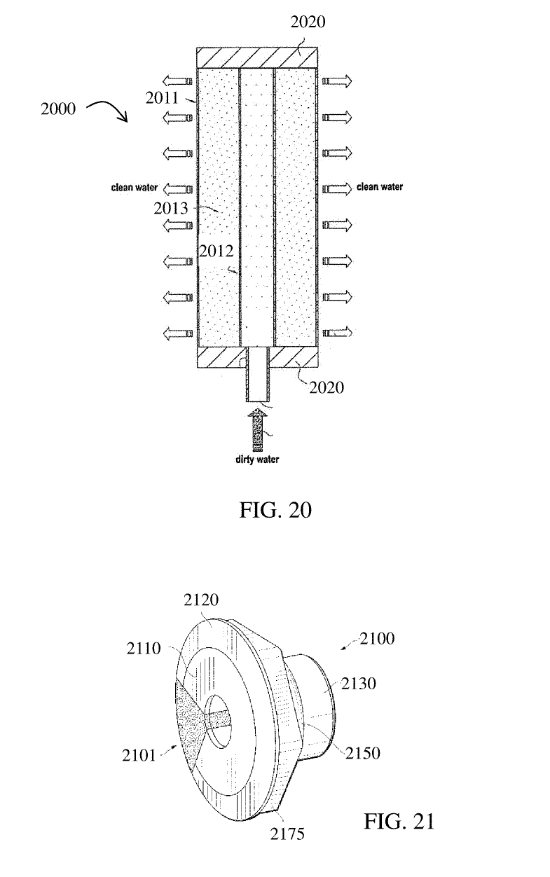

FIG. 18 shows another example of a component formed according to embodiments of the present disclosure, where the component is a flow diverter 1800 formed by infiltrating together at least two binder jetted green segments made with different matrix materials. The flow diverter 1800 shown in FIG. 18 includes a body 1802 that is elongated or extended along the longitudinal axis L and formed in the tubular wall 1808 of the drive shaft 1806. The flow diverter 1800 may include a plurality of apertures 1804 for diverting the flow A, B of the drilling fluid from an upstream section of the system to a bearing section of the system. The body 1802 may have any shape and size suitable for the drilling conditions, the overall drilling system and the torque requirements of the drive shaft 1806. Other flow diverter types and configurations may be formed according to methods of the present disclosure.

FIG. 19 shows a pump 1901 formed according to embodiments of the present disclosure, where multiple green segments binder jetted from different matrix materials are infiltrated together to form the pump 1901. The pump 1901 shown in FIG. 19 is a positive displacement pump, which may employ a valve actuation guide assembly 1900. However, other types of pumps may be formed according to embodiments of the present disclosure.

The pump 1901 may include a crankshaft housing coupled to a plunger housing 1980 which is in turn coupled to a chamber housing. The pump components may be accommodated at a skid to enhance mobility, for example, for placement at an oilfield. However, in other embodiments a pump truck or a less mobile pump configuration may be employed. Additionally, the pump 1901 may be of a conventional triplex configuration as depicted. However, other positive displacement pump configurations may also be employed. The chamber housing of the pump 1901 may be configured with valves (1950, 1955) to draw in, pressurize, and dispense an operation fluid. The valve actuation guide assembly 1900 may also be provided which is coupled to the chamber housing. The guide assembly 1900 may be configured to assist valves (e.g. 1950) in controlling or regulating fluid ingress and egress relative to the chamber housing. This valve assistance provided by the guide assembly 1900 may minimize pump damage during operation and enhance overall efficiency of the pump 1901.

A valve actuation guide of the guide assembly 1900 may be configured to assist in actuation of a valve 1955 of the chamber housing. The valve actuation guide may be mechanically coupled to the suction valve 1955 of the chamber housing. In some embodiments, a valve actuation guide may similarly be coupled to the discharge valve 1950 of the housing or other valves not depicted. Additionally, the valve actuation guide may be of a crank-driven configuration. However, in other embodiments, hydraulic, electromagnetic, or other valve actuation assistance may be employed.

The pump 1901 may be provided with a plunger 1990 reciprocating within a plunger housing 1980 toward and away from a pressure-capable chamber 1935. In this manner, the plunger 1990 effects high and low pressures on the chamber 1935. For example, as the plunger 1990 retreats away from the chamber 1935, the pressure therein will decrease. As the pressure within the chamber 1935 decreases, the discharge valve 1950 may close returning the chamber 1935 to a sealed state. As the plunger 1990 continues to move away from the chamber 1935 the pressure therein will continue to drop, and eventually a lowered pressure may begin to arise within the chamber 1935.

The valve actuation guide may be employed to ensure that the suction valve 1955 is raised in order to allow a communication path 1909 between a supply 1945 of operation fluid and the chamber 1935. As such, the uptake of operation fluid may be achieved without sole reliance on lowered pressure overcoming a suction spring 1975. Thus, substantial vaporization of operation fluid within the chamber 1935 may be avoided. Avoidance of substantial vaporization of operation fluid in this manner may substantially minimize the amount of pump damage that may otherwise result as the plunger 1990 re-pressurizes and condenses the operation fluid. That is, water-hammering damage due to the rapid condensing of vaporized operation fluid may be largely avoided. As such, in the embodiment shown, the plunger 1990 may be thrust toward the chamber 1935, increasing the pressure therein. The pressure increase will ultimately be enough to effect opening of the discharge valve 1950 overcoming the force supplied by the discharge spring 1970.

Different regions of the pump 1901 may be subjected to different amounts of wear and/or fatigue. Regions experiencing greater amounts of wear may be formed of one or more green segments binder jetted from a wear resistant matrix material and a binder, and regions experiencing lesser amounts of wear may be formed of one or more green segments binder jetted from a different matrix material and the binder. In some embodiments, regions of the pump subjected to large amounts of friction (e.g., between valves 1950, 1955 and the channels in which they are disposed) may be formed of one or more green segments binder jetted from a friction matrix material, and adjacent regions may be formed of one or more green segments binder jetted from a different matrix material. For example, valves 1950, 1955 may each be formed by binder jetting two green segments, including an outer green segment formed with a friction matrix material and an interior green segment formed with a different matrix material, assembling the green segments together such that the outer green segment forms the outer surface of the valve, removing the binder, and infiltrating the green valves with a metallic infiltrant.

Other combination of regions in components of a pump may be formed by binder jetting green segments from different matrix materials, assembling the green segments together, and infiltrating the green segments together with a metallic infiltrant according to embodiments of the present disclosure.

FIG, 20 shows a schematic cross sectional view of a filter cartridge 2000 according to embodiments of the present disclosure. The filter includes a perforated outer pipe 2011, a perforated inner pipe 2012, and filtering media 2013 disposed there between. The filter cartridge is terminated at its extremities by lids 2020. At least one region of the filter cartridge may be formed of a matrix material different from another region of the filter cartridge. Other filter types and screens may be formed using methods disclosed herein.

FIG. 21 shows a downhole nozzle 2100 formed according to methods of the present disclosure, where at least two green segments are formed by binder jetting different matrix materials and are infiltrated together to form the nozzle. The downhole nozzle 2100 includes a channel 2110, an exposed cover 2120 that transitions into a main body 2175, and seal 2150 coupled to a cylinder housing 2130 that surrounds the nozzle channel 2110. As sand-based perforating fluids are jetted out of the nozzle channel 2110, erosion begins to take place at defining surfaces of this channel 2110 and the nozzle cover 2120.

In the embodiment shown, the nozzle 2100 may have a hard region 2101 formed from a first green segment binder jetted from a durable carbide-based matrix material, and the remaining regions of the nozzle may be formed of one or more green segments binder jetted from a different matrix material. The green segments may be assembled together and infiltrated with a metallic infiltrant to form the nozzle 2100.

FIG. 22 shows a cross sectional view of a valve seat 2222 formed using methods according to embodiments of the present disclosure disposed in a valve 2210. The valve 2210 includes a housing 2212, a sleeve for retaining the valve in an open position, a curved flapper 2220, the valve seat 2222, and a connecting device 2230. Housing 2212 includes a region 2232 where the wall of housing 2212 has been thinned relative to other regions of housing 2212. Region 2232 is configured such that flapper flapper 2220 may be retained substantially within region 2232 when in the open position without substantially reducing the inner diameter of housing 2212. Region 2232 may have an arcuate profile in a region proximate to flapper 2220. The arcuate profile may approximate an arc traced by flapper 2220 as flapper 2220 moves from a first open position to a second closed position. Valve seat 2222 and flapper 2220 may be configured to have thicknesses similar to the difference in thickness of housing 2212 and the region 2232 and other regions of housing 2212. Region 2232 may be generally cylindrical in shape.

Extension 2234 extends from valve seat 2222 to collar 2236. Extension 2232 may be provided with an opening 2236 to accommodate flapper 2220 when flapper 2220 is in a closed position. In the same or other embodiments, extension 2234 may be provided with a thinned region for accommodating a portion of flapper 2220.

FIG. 22 shows flapper 2220 in a closed position and seated in the valve seat 2222. A sleeve has been withdrawn from housing 2212, where upon withdrawal of sleeve, flapper 2220 may close and form a seal with seat 2222 to block channel 2213. In some embodiments, a polymer sealing member may be used to provide a seal between flapper 2220 and seat 2222. Flapper 2220 may be biased into the closed position by springs or other means to help ensure that the valve closes when the sleeve is withdrawn. In other embodiments, flapper 2220 may be oriented such that it is urged towards the closed position by its own weight. For example, in a deviated well (i.e. a non-vertical well) flapper 2220, may be oriented such that flapper 2220 will swing to the closed position by gravity without the use of springs or other biasing mechanisms.

According to some embodiments of the present disclosure, the valve seat 2222 may be formed of at least two different green segments (e.g., a green segment forming the region of the seat to contact the flapper 2220 and a green segment forming the remaining regions of the seat) where each green segment is formed of a different matrix material according to methods disclosed herein. The green segments may be assembled together (e.g., at interlocking interfaces) and the binder removed. The green valve seat may then be infiltrated with a single metallic infiltrant to form the valve seat 2222. Other components in a valve may be formed by infiltrating together different green segments according to embodiments of the present disclosure to provide different material properties at the different regions of the component.

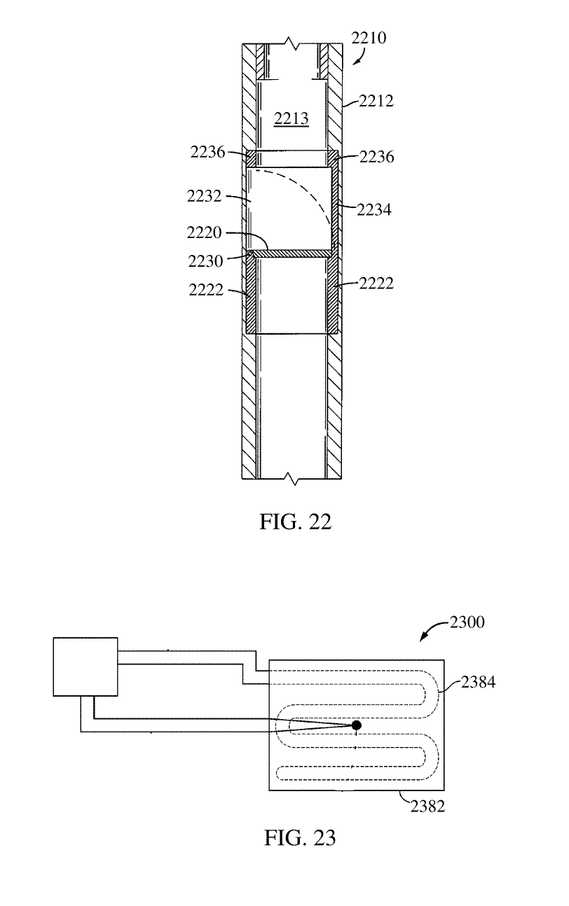

FIG. 23 shows a schematic representation of a heat exchanger 2300 having one or more components formed according to methods of the present disclosure. For example, a heat exchanger may have an increased surface area section of tubing 2384 or channels. Fluid (liquid or gas) having a first temperature may be flowed through the tubing, and fluid (liquid or gas) having a second temperature different than the first temperature may be disposed in chamber 2382. As the fluid is flowed through the tubing 2384 in the chamber 2382, heat may be exchanged between the tubing walls. Environmental factors in the heat exchanger (e.g., differential temperatures between the tubing walls, different types of fluid used, etc.) may subject the tubing to corrosion and/or cracking.

According to some embodiments, regions of the tubing 2384 that may be more exposed to corrosion and/or cracking (e.g., an outer surface region of the tubing or curved portions of the tubing) may be formed of green segment(s) binder jetted from a matrix material more suitable for preventing or reducing incidence of corrosion and/or cracking than a different matrix material used to form remaining green segment(s) of the tubing 2384. The green segments of the tubing may be assembled together, heated to remove the binder, and infiltrated with a metallic infiltrant to form the tubing 2384.

Other embodiments may have different regions of a heat exchanger component segmented into green segments formed of different matrix materials, assembled together, heated to remove the binder, and infiltrated with a metallic infiltrant according to methods disclosed herein.

According to some embodiments of the present disclosure, a degradable component made of metals, ceramics, or composites may be formed according to methods of the present disclosure. In such embodiments, the degradable component may be formed by binder jetting at least two different green segments of the component, where at least two different green segments are formed with different matrix material having different electrochemical potentials to degrade galvanically in a water-based environment. For example, a first green segment may be formed by binder jetting a first matrix material and a second green segment may be formed by binder jetting a second matrix material, where the first and second matrix materials have different electrochemical potentials to degrade galvanically in a water-based environment (e.g., in seawater). The first and second green segments may be infiltrated together to form a component for use in downhole operations. During use of the component, a region in the component formed with a matrix material having higher potential to degrade in the water-based environment may degrade over different regions in the component.

Other components for use in downhole operations and drilling equipment (including subsea and above surface equipment) may be formed according to additive manufacturing methods disclosed herein, where different regions of the component may be formed as separate green segments and infiltrated together to form the component. For example, green segments may be binder jetted from a binder and different matrix materials and assembled together, where the binder may be at least partially removed prior to infiltrating the green segments together. Green segments may be delineated according to the functionality of the region in the component that each green segment forms. In other words, according to some embodiments, a component design may be divided into different regions based on the functionality of each region, and the component may be formed according to the component design by forming each region as a green segment and infiltrating the green segments together. Examples of green segments (pre-infiltrated) and regions (post-infiltrated) delineated according to functionality may include portions of a component that are subjected to different environments during use of the component, such as portions that experience relatively higher wear, relatively higher torque, relatively higher erosion, relatively higher impact, and/or other factors, compared with different portions of the component.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A method, comprising:
depositing successive layers of a first binder and first particles comprising a first material using a layering device to build a first green segment;
depositing successive layers of a second binder and second particles comprising a second material different than the first material using the layering device to build a second green segment;
assembling the first green segment and the second green segment together to form a green component; and
infiltrating the green component with a metallic infiltrant to form a component.

2. The method of claim 1, further comprising:
placing the green component into a vacuum furnace; and
heating the green component to burn out the first binder and second binder.

3. The method of claim 1, wherein depositing the first binder and first particles comprises:
providing a layer of the first particles in powder form; and
dispensing the first binder selectively over the layer of powder.

4. The method of claim 1, wherein the volume ratio of the first binder to the first material within the first green segment varies among different layers.

5. The method of claim 1, wherein a first volume ratio of the first binder to the first material within the first green segment is different than a second volume ratio of the second binder to the second material within the second green segment.

6. The method of claim 1, further comprising:
designing a microstructure of the component, the microstructure having varying volume ratios of metallic infiltrant to the first material and to the second material; and
depositing greater amounts of first binder and second binder in areas to have greater volume ratios of metallic infiltrant to the first material and to the second material.

7. The method of claim 1, wherein the first segment and the second segment have interlocking features.

8. The method of claim 1, wherein the metallic infiltrant is selected from at least one of a bronze alloy, a copper alloy, a nickel alloy, and a cobalt alloy.

9. The method of claim 1, wherein the first material has a greater erosion resistance and a lower toughness than the second material, or wherein the first binder and the second binder have the same material composition.

10. The method of claim 1, where the first binder and second binder have the same material composition.

11. A method, comprising:
designing a component using a computer aided design program, the component comprising at least two segments;
depositing a binder and matrix material layer by layer using a layering device to build each segment separately;
assembling the at least two segments together to form a green component; and
infiltrating the green component with a metallic infiltrant to form the component.

12. The method of claim 11, further comprising hot isostatic pressing the component.

13. The method of claim 11, further comprising:
placing at least one insert in the green component prior to infiltrating, the at least one insert comprising a material having a melting temperature greater than the metallic infiltrant.

14. A component for downhole operation equipment, comprising:
a microstructure comprising a metallic infiltrant dispersed in a matrix of at least two types of matrix material particles, wherein each type of matrix material particle is in a separate region of the component; and
an interlocking interface between two of the separate regions.

15. The component of claim 14, wherein the separate regions of the component comprise a wear resistant region and a tough region, and wherein a first type of matrix material particles forming the wear resistant region has greater wear resistance than a second type of matrix material particles forming the tough region.

16. The component of claim 14, wherein the interlocking interface comprises mating castellations.

17. The component of claim 14, wherein the mean free path between matrix material particles is different in two of the separate regions.

18. The component of claim 14, wherein a volume ratio of the metallic infiltrant to the matrix material particles varies through one of the separate regions.

19. The component of claim 14, where the component is an axial pulse generator comprising:
a first region comprising the metallic infiltrant and a first type of matrix material particles;
a second region positioned adjacent to the first region, the second region comprising the metallic infiltrant and a second type of matrix material particles; and
a third region positioned adjacent to the second region, the third region comprising the metallic infiltrant and a third type of matrix material particles;
wherein the third type of matrix material particles have a greater toughness than the first and second types of matrix material particles; and
wherein the first type of matrix material particles has a greater erosion resistance than the second and third types of matrix material particles.

20. The component of claim 14, wherein the component is a rotor, comprising:
a body comprising the metallic infiltrant and a first type of matrix material particles; and
a plurality of blades extending from the body, the blades comprising the metallic infiltrant and a second type of matrix material particles.
